(19) United States
(12) Patent Application Publication
(10) Pub. No.: US 2020/0064556 A1
(43) Pub. Date: Feb. 27, 2020

(54) NxN Optical Switch

(71) Applicant: NIPPON TELEGRAPH AND TELEPHONE CORPORATION, Tokyo (JP)

(72) Inventors: Yusuke Muranaka, Atsugi-shi, Kanagawa-ken (JP); Tatsushi Nakahara, Atsugi-shi, Kanagawa-ken (JP); Toshikazu Hashimoto, Atsugi-shi, Kanagawa-ken (JP)

(21) Appl. No.: 16/608,084

(22) PCT Filed: Apr. 19, 2018
(86) PCT No.: PCT/JP2018/016131

§ 371 Date: Oct. 24, 2019

(30) Foreign Application Priority Data
Apr. 26, 2017 (JP) 2017-086865

(51) Int. Cl. G02B 6/35

(52) U.S. Cl. CPC G02B 6/3546; G02B 6/3548; G02B 6/356

(57) ABSTRACT

There is provided an N×N optical switch configured by connection between output ports of input side optical switches and input ports of output side optical switches by using optical waveguides on the same substrate and capable of reducing the crossing loss in a port connected to an optical waveguide having a maximum number of crossings and a higher crossing loss. In a 4×4 optical switch (10) having four input side 1×4 optical switches (SW11-SW14) each having four output ports (P1-P4), four output side 4×1 optical switches (SW21-SW24) each having four input ports (Q1-Q4), and connection optical waveguides (OW) connecting the output ports and the input ports, part of the connection optical waveguides OW are allowed to cross two or more of the other connection optical waveguides OW in one point.

### TECHNICAL FIELD

The present invention relates to an N×N optical switch, which is an important optical component for supporting large-capacity optical communication networks.

### BACKGROUND ART

Recently, high-speed and large-capacity optical communication networks have been developed to cope with the rapid increase in communication traffic. The optical communication network is composed of a plurality of links and nodes, and research and development of the links and nodes have been conducted for high-speed and large-capacity communications.

For the links, progress has been made in high-speed signal transmission, wavelength multiplexing, and the like, whereas, for the nodes, the importance of a technique for flexibly changing paths connecting the nodes has been recognized to achieve efficient communication traffic. For example, there is known a transmission technique in which a transmitted optical signal is temporarily subjected to optical-to-electrical conversion at an input end of a node, then switching is performed on an electrical signal, and the electrical signal is converted back to an optical signal at an output end of the node. In this case, a considerable amount of power is used in the optical-to-electrical conversion and the high-speed switching of the electrical signals.

Meanwhile, research and development have been conducted on a technique in which an optical switch is placed in a node and an optical signal is switched without being converted into an electrical signal. In this case, since an optical signal is directly switched in the optical switch to change its path, there is no need of optical-to-electrical conversion and high-speed switching of electrical signals, allowing switching of high-speed optical signals with low delay and low power consumption.

For such optical switches, research and development have been conducted on, for example, a thermo-optic (TO) switch configured on a planar lightwave circuit (PLC), a switch using an InP-based electroabsorption modulator (EAM), a Mach-Zehnder interferometer (MZI), or a semiconductor optical amplifier (SOA), and a LiNbO₃-based phase modulator type switch.

For example, NPL 1 proposes an example of configuring an optical switch on a PLC.

As disclosed also in NPL 1, examples of a main configuration of an N×N optical switch include a configuration of connecting N 1×N optical switches and N N×1 optical switches (where N is a positive integer).

FIG. 5 shows an example of a conventional N×N optical switch 100. As shown in FIG. 5, the conventional N×N optical switch 100 is composed of N input side 1×N optical switches SW11-SW1N and N output side N×1 optical switches SW21-SW2N (N=4 in FIG. 5; details will be described later).

Optical packets inputted from input ports are outputted from the input side 1×N optical switches SW11-SW1N to the output side N×1 optical switches SW21-SW2N connected to desired output ports. This configuration can achieve a non-blocking type N×N optical switch that allows any connection regardless of the connection states of the other ports.

Here, as the conventional technique for configuring an input side 1×N optical switch, for example, PTL 1 proposes a 2×2 optical switching element. FIG. 6 shows a perspective view of the conventional 2×2 optical switching element. The 2×2 optical switching element of FIG. 6 is a directional coupler type optical switching element and is composed of an optical input unit I, an optical switching unit II, an optical output unit III, and an optical absorption unit IV, which are provided on an n-InP substrate 6.

More specifically, the conventional 2×2 optical switching element shown in FIG. 6 has a structure that an i-MQW layer 5, an i-InP cladding layer 4, and a p-InP cladding layer 3 are laminated on the n-InP substrate 6 in this order. The p-InP cladding layer 3 is formed in a fine-line manner as shown in FIG. 6. Furthermore, on either one of the p-InP cladding layers 3 of the optical switching unit II and on both p-InP cladding layers 3 of the optical absorption unit IV, a p⁺-InGaAs cap layer 2 and a p-type electrode 1 are formed in this order. On a back side of the n-InP substrate 6, an n-type electrode 7 is formed. Note that, in FIG. 6, reference signs A, B denote input ports and reference signs C, D denote output ports.

Input signal light such as an optical packet is guided through a portion located below the p-InP cladding layer 3 formed in a fine-line manner inside the i-MQW layer 5. In the following description, the i-MQW layer 5 located below the p-InP cladding layer 3 provided in the optical input unit I, the optical switching unit II, the optical output unit III, and the optical absorption unit IV is individually referred to as an input waveguide, an optical switch waveguide, an output waveguide, and an optical absorption waveguide.

The input signal light enters either one of the input waveguides and is led to the optical switch waveguide. In the optical switch waveguide, by applying a desirable voltage across the p-type electrode 1 and the n-type electrode 7 provided in the optical switching unit II, a refractive index of the optical switch waveguide below the p-type electrode 1 is changed due to, for example, a quantum confined stark effect (QCSE) produced by a multiple quantum well (MQW) structure, thereby outputting the signal light only from either one of the optical switch waveguides. In other words, switching of the optical path is performed. In the optical absorption unit IV, a desired electrical field is applied across the p-type electrode 1 and the n-type electrode 7 provided in an optical absorption waveguide that is different from the optical absorption waveguide which the signal light has entered. This allows crosstalk light leaking from the optical switch waveguide to be absorbed in the optical absorption waveguide and also allows the signal light outputted from the optical switch waveguide to be led to the output waveguide. In this manner, in PTL 1, providing the optical absorption unit IV can achieve an optical switching element that can decrease an influence of light leaking from the optical switch waveguide.

### CITATION LIST

### Patent Literature

PTL 1: Japanese Patent Laid-Open No. H06-59294(1994)
PTL 2: Japanese Patent Laid-Open No. 2016-161604

### Non Patent Literature

NPL 1: T. Watanabe, et al., “Silica-based PLC 1×128 Thermo-Optic Switch,” 27th European Conference on Optical Communication (ECOC), 2001, Vol. 2, pp. 134-135

### SUMMARY OF INVENTION

In the above-mentioned NPL 1, N input side 1×N optical switches and N output side N×1 optical switches are connected by optical fibers to achieve an N×N optical switch. In this case, N×N optical fibers and 2×N×N fiber connecting points and connectors are needed, which increases the size of the optical switch. Furthermore, there is a great mode mismatch between a waveguide having strong optical confinement, particularly a semiconductor optical waveguide, and an optical fiber, resulting in a great loss at the time of optical coupling. In this configuration, coupling loss occurs four times in each path, increasing the insertion loss of the N×N optical switch.

To achieve a smaller N×N optical switch with lower loss, there is an idea of providing the connection by the waveguides on the same substrate (see, for example, the above-mentioned PTL 2).

Here, to achieve the configuration of the N×N optical switch shown in FIG. 5 on the same substrate, an area having the mechanism of switching 1×N optical paths and an area having the mechanism of switching N×1 optical paths are prepared by input side 1×N optical switches and output side N×1 optical switches, respectively, to place N input side 1×N optical switches and N output side N×1 optical switches. These are connected by the waveguides on the same substrate.

A detailed description will be given of an example of the case where N=4 as shown in FIG. 5. In a 4×4 optical switch shown in FIG. 5, input side 1×4 optical switches SW11-SW14 are aligned, and output side 4×1 optical switches SW21-SW24 are aligned opposite to the input side 1×4 optical switches SW11-SW14.

Each of the input side 1×4 optical switches SW11-SW14 has four output ports P1-P4. Furthermore, each of the output side 4×1 optical switches SW21-SW24 has four input ports Q1-Q4. In FIG. 5, each port is shown by an open circle.

The four output ports P1-P4 of the respective input side 1×4 optical switches SW11-SW14 are connected to the input ports Q1-Q4 of the output side 4×1 optical switches SW21-SW24 that are different from each other by connection optical waveguides OW. For simplicity, the connection optical waveguides OW are shown by solid lines in FIG. 5.

In such a structure, the input side 1×4 optical switches SW11-SW14 and the output side 4×1 optical switches SW21-SW24 are connected on a plane, and thus, while part of the connection optical waveguides OW do not cross other connection optical waveguides OW, many of the connection optical waveguides OW cross other connection optical waveguides OW multiple times. The number of crossings of the connection optical waveguide OW with respect to other connection optical waveguides OW is (N−1)×(N−1) times at the maximum ((4−1)×(4−1)=9 times in the example shown in FIG. 5).

For example, in the 4×4 optical switch shown in FIG. 5, the connection optical waveguide OW connecting the output port P1 of the input side 1×4 optical switch SW11 and the input port Q1 of the output side 4×1 optical switch SW21 does not cross other connection optical waveguides OW. However, the connection optical waveguide OW connecting the output port P4 of the input side 1×4 optical switch SW11 and the input port Q1 of the output side 4×1 optical switch SW24 crosses nine connection optical waveguides OW.

Accordingly, assuming that optical loss caused by one crossing of the connection optical waveguide OW with another connection optical waveguide OW is expressed by L (dB/the number of crossings), the optical loss (hereinafter referred to as crossing loss) caused by the crossing of the connection optical waveguide OW of a port connected to this connection optical waveguide OW is L×(N−1)×(N−1) (dB) at the maximum. More specifically, assuming L=0.5 dB, a maximum crossing loss of the port is 4.5 dB if N=4, and a maximum crossing loss of the port is 24.5 dB if N=8. It is found that as N increases, the crossing loss greatly increases.

In the case of the optical switch, since the ports need to have the same output light intensity, a loss value of a port other than the ports connected to the connection optical waveguide OW having a maximum crossing loss is adjusted by preparing a different loss source. Accordingly, for the connection optical waveguide OW having a maximum number of crossings with other connection optical waveguides OW, there is a need for reducing the number of crossings.

In view of the above conventional technique, an object of the present invention is to achieve an N×N optical switch configured by connection between output ports of input side 1×N optical switches and input ports of output side N×1 optical switches by using connection optical waveguides on the same substrate and capable of reducing the crossing loss in a port connected to a connection optical waveguide having a maximum number of crossings and a higher crossing loss.

According to one embodiment of the present invention, there is provided an N×N optical switch comprising: N input side 1×N optical switches each having N (where N is an integer equal to or greater than 3) output ports; N output side N×1 optical switches each having N input ports; and connection optical waveguides connecting the output ports and the input ports, wherein part of the connection optical waveguides cross two or more of the other connection optical waveguides in one point.

According to another embodiment of the present invention, there is provided an N×N optical switch, wherein an MMI crossing structure is used in a crossing portion in which the connection optical waveguide crosses the other connection optical waveguides.

According to another embodiment of the present invention, there is provided an N×N optical switch, wherein the input side 1×N optical switches and the output side N×1 optical switches are separately aligned such that the output ports and the input ports are opposite to each other,
the output port in one end of the input side 1×N optical switch being located in one end among the input side 1×N optical switches is connected to the input port in one end of the output side N×1 optical switch being located in one end among the output side N×1 optical switches by the connection optical waveguide that does not cross the other connection optical waveguides,
the output port in the other end of the input side 1×N optical switch being located in the other end among the input side 1×N optical switches is connected to the input port in the other end of the output side N×1 optical switch being located in the other end among the output side N×1 optical switches by the connection optical waveguide that does not cross the other connection optical waveguides,
the output ports located other than in one end of the input side 1×N optical switch being located in one end among the input side 1×N optical switches are connected to the input ports of the output side N×1 optical switches being located other than in one end among the output side N×1 optical switches and being different from each other by the connection optical waveguides that cross the other connection optical waveguides,
the output ports located other than in the other end of the input side 1×N optical switch being located in the other end among the input side 1×N optical switches are connected to the input ports of the output side N×1 optical switches being located other than in the other end among the output side N×1 optical switches and being different from each other by the connection optical waveguides that cross the other connection optical waveguides, and
the output ports of the input side 1×N optical switches being located other than in two ends among the input side 1×N optical switches are connected to the input ports of the output side N×1 optical switches being different from each other by the connection optical waveguides that cross the other connection optical waveguides.

According to another embodiment of the present invention, there is provided an N×N optical switch, wherein the input side 1×N optical switches and the output side N×1 optical switches are alternately arranged in alignment,
the output ports located in two ends of the input side 1×N optical switch are connected to the input ports located in end portions of the output side N×1 optical switches being adjacent to the input side 1×N optical switch and being different from each other by the connection optical waveguides that do not cross the other connection optical waveguides, and
among the output ports of the input side 1×N optical switch, the output ports located other than in two ends are connected to the input ports located other than in two ends of the output side N×1 optical switches not being adjacent to the input side 1×N optical switch and being different from each other by the connection optical waveguides that cross the other connection optical waveguides.

According to another embodiment of the present invention, there is provided an N×N optical switch, wherein the input side 1×N optical switches, the output side N×1 optical switches, and the connection optical waveguides are formed as monolithic integration on a same semiconductor substrate.

According to another embodiment of the present invention, there is provided an N×N optical switch, wherein crossing angles in the crossing portion in which the connection optical waveguide crosses the other connection optical waveguides are equal.

According to the N×N optical switch of one embodiment of the present invention, there is provided an optical switch configured by connection between output ports of input side 1×N optical switches and input ports of output side N×1 optical switches by using connection optical waveguides on the same substrate, wherein crossing loss caused by the crossing of the waveguides in a port connected by a connection optical waveguide having a maximum number of crossings with other connection optical waveguides can be reduced.

### BRIEF DESCRIPTION OF DRAWINGS

FIG. 1 is a configuration diagram showing an example of a tree-type optical switch applied to an N×N optical switch according to an embodiment of the present invention.

FIG. 2 is a configuration diagram showing an N×N optical switch according to the first embodiment of the present invention.

FIG. 3 is a configuration diagram showing an MMI crossing structure in a case where three waveguides cross each other.

FIG. 4 is a configuration diagram showing an N×N optical switch according to the second embodiment of the present invention.

FIG. 5 is a configuration diagram showing an example of a conventional N×N optical switch.

FIG. 6 is a perspective view of a conventional 2×2 optical switching element.

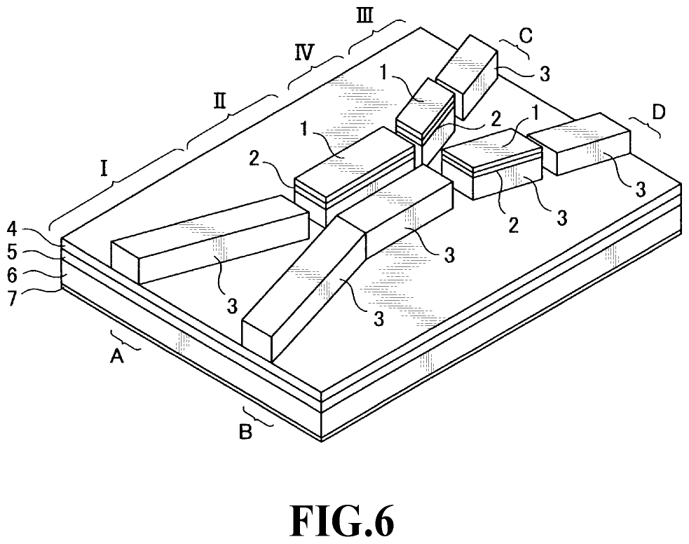

FIG. 7 is a configuration diagram showing another example of the conventional N×N optical switch.

### DESCRIPTION OF EMBODIMENTS

An N×N optical switch according to an embodiment of the present invention is configured by connection between output ports of N input side 1×N optical switches and input ports of N output side N×1 optical switches by using connection optical waveguides formed on a substrate, wherein the connection optical waveguides are placed to have a waveguide crossing portion in which three or more connection optical waveguides cross each other in one point, and a multi-mode interference (MMI) crossing structure is used in the waveguide crossing portion where the connection optical waveguide crosses other connection optical waveguides connecting ports.

According to the N×N optical switch according to an embodiment of the present invention, this configuration allows one connection optical waveguide to have a reduced number of waveguide crossing portions and also can achieve a low loss and low crosstalk crossing in the waveguide crossing portion, thereby reducing the optical loss caused by the crossing of the waveguides.

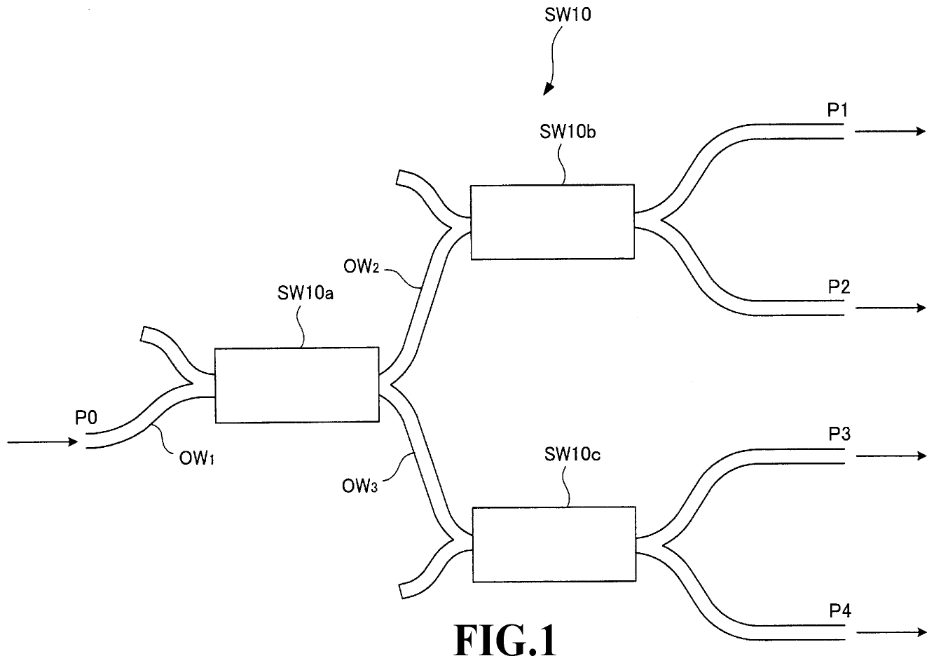

Here, with reference to FIG. 1, a tree-type optical switch used in one embodiment of the present invention will be described. The optical switch is not limited to a 1×4 optical switch. A 1×8 optical switch or a 1×N optical switch having a larger number of ports may be employed. Hereinafter, a typical tree-type 1×4 optical switch will be described.

As shown in FIG. 1, a 1×4 optical switch SW10 is achieved by connecting 2×2 optical switches SW10a, SW10b, SW10c in a tree manner. The light output is split into two in the first 2×2 optical switch SW10a, and then the split light output is individually split into two in the next 2×2 optical switches SW10b, SW10c, so that the output is consequently split among four ports. Each of the 2×2 optical switches SW10a, SW10b, SW10c may be achieved by using, for example, a MZI.

The 2×2 optical switches SW10a, SW10b, SW10c first use a multimode interference optical coupler (hereinafter referred to as an MMI optical coupler) for input light entering an optical waveguide (for example, an OW₁ shown in FIG. 1) and split the input light between two optical waveguides (not shown). At this time, the length of the MMI optical coupler is designed to split the optical intensity into two equal parts. The two parts of the split input light receive a phase difference between two optical waveguides and then are coupled again by using the MMI optical coupler. As a result, due to an interference effect, if the phase difference between the two optical waveguides is ±nπ, the input light is outputted from an optical waveguide (for example, an OW₂ shown in FIG. 1) opposite to the optical waveguide which the input light has entered, while if the phase difference between the two optical waveguides is ±(2n+1)π/2, the input light is outputted from an optical waveguide (for example, an OW₃ shown in FIG. 1) in the same side of the optical waveguide which the input light has entered (where n is an integer).

Accordingly, by placing and controlling a phase modulation area in either one of the optical waveguides, a 2×2 switching operation can be obtained. To obtain phase modulation, a refractive index of an optical waveguide may be changed. Accordingly, a switching operation may be performed in the following manner: in a PLC or the like, current is applied through a heater to control the temperature and a refractive index of an optical waveguide is changed by using a TO effect; in an InP based optical waveguide, a Franz-Keldysh (FK) effect and a quantum confined stark effect (QCSE) produced by voltage application or a plasma effect produced by current infusion is used to change a refractive index of an optical waveguide; and in an LN based optical waveguide, a Pockels effect produced by voltage application is used to change a refractive index of an optical waveguide. Furthermore, a directional coupler and the like may be used for the MMI optical coupler that splits the optical intensity into two equal parts.

### First Embodiment

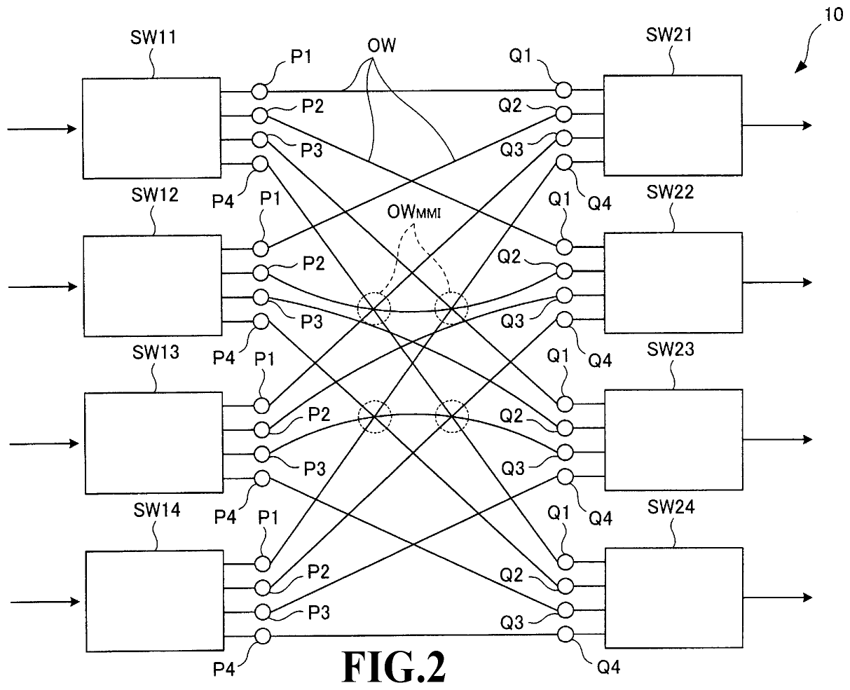

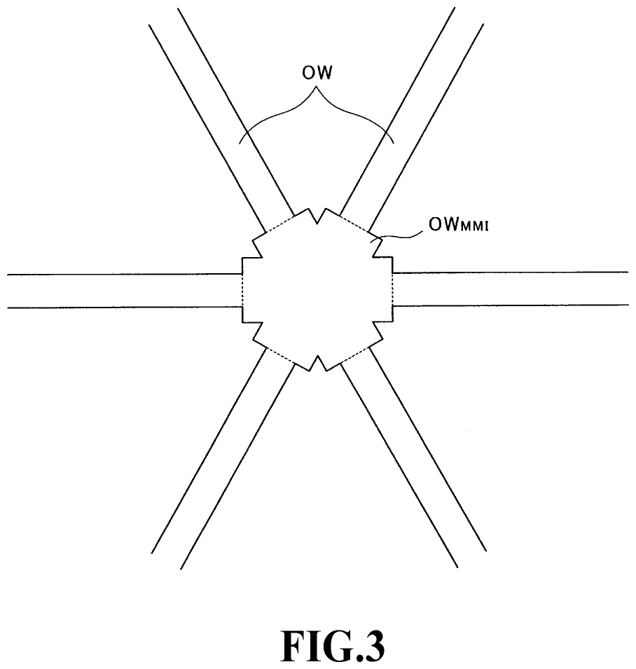

With reference to FIG. 2 and FIG. 3, a detailed description will be given of an N×N optical switch according to the first embodiment of the present invention.

In the present embodiment, as an optical switch, an N×N optical switch comprises N input side 1×N optical switches each having N output ports, N output side N×1 optical switches each having N input ports, and connection optical waveguides connecting the output ports and the input ports. FIG. 2 shows an example of a basic connection configuration, where N=4.

As shown in FIG. 2, a 4×4 optical switch 10 comprises four input side 1×4 optical switches SW11-SW14 and four output side 4×1 optical switches SW21-SW24. The input side 1×4 optical switches SW11-SW14 are aligned, and the output side 4×1 optical switches SW21-SW24 are aligned opposite to the input side 1×4 optical switches SW11-SW14.

Each of the input side 1×4 optical switches SW11-SW14 has four output ports P1-P4. Furthermore, each of the output side 4×1 optical switches SW21-SW24 has four input ports Q1-Q4.

The four output ports P1-P4 of the respective input side 1×4 optical switches SW11-SW14 are connected to the input ports Q1-Q4 of the output side 4×1 optical switches SW21-SW24 that are different from each other by connection optical waveguides OW.

As a specific connection method between the input side 1×4 optical switches SW11-SW14 and the output side 4×1 optical switches SW21-SW24, FIG. 2 shows the following example. The output ports P1-P4 of the input side 1×4 optical switch SW11 are respectively connected to the input ports Q1 of the output side 4×1 optical switches SW21-SW24; the output ports P1-P4 of the input side 1×4 optical switch SW12 are respectively connected to the input ports Q2 of the output side 4×1 optical switches SW21-SW24; the output ports P1-P4 of the input side 1×4 optical switch SW13 are respectively connected to the input ports Q3 of the output side 4×1 optical switches SW21-SW24; and the output ports P1-P4 of the input side 1×4 optical switch SW14 are respectively connected to the input ports Q4 of the output side 4×1 optical switches SW21-SW24.

In other words, the output port P1 in one end of the input side 1×4 optical switch SW11 in one end is connected to the input port Q1 in one end of the output side 4×1 optical switch SW21 in one end by a connection optical waveguide OW that does not cross another connection optical waveguide OW.

Meanwhile, the output port P4 in the other end of the input side 1×4 optical switch SW14 in the other end is connected to the input port Q4 in the other end of the output side 4×1 optical switch SW24 in the other end by a connection optical waveguide OW that does not cross another connection optical waveguide OW.

Furthermore, the output ports P2-P4 located other than in one end of the input side 1×4 optical switch SW11 in one end are respectively connected to the input ports Q1 of the output side 4×1 optical switches SW22-SW24 that are located other than in the other end and are different from each other by connection optical waveguides OW that cross other connection optical waveguides OW.

Moreover, the output ports P1-P3 located other than in the other end of the input side 1×4 optical switch SW14 in the other end are respectively connected to the input ports Q4 of the output side 4×1 optical switches SW21-SW23 that are located other than in the other end and are different from each other by connection optical waveguides OW that cross other connection optical waveguides OW.

The output ports P1-P4 of the input side 1×4 optical switches SW12, SW13 located other than in the two ends are respectively connected to the input ports Q2, Q3 of the output side 4×1 optical switches SW21-SW24 that are different from each other by connection optical waveguides OW that cross other connection optical waveguides OW.

It should be noted that the input side 1×4 optical switches SW11-SW14, the output side 4×1 optical switches SW21-SW24, and the connection optical waveguides OW are formed as monolithic integration on the same semiconductor substrate.

In this case, the connection optical waveguides OW having a maximum number of crossings include the connection optical waveguide OW connecting the output port P4 of the input side 1×4 optical switch SW11 to the input port Q1 of the output side 4×1 optical switch SW24 and the connection optical waveguide OW connecting the output port P1 of the input side 1×4 optical switch SW14 to the input port Q4 of the output side 4×1 optical switch SW21.

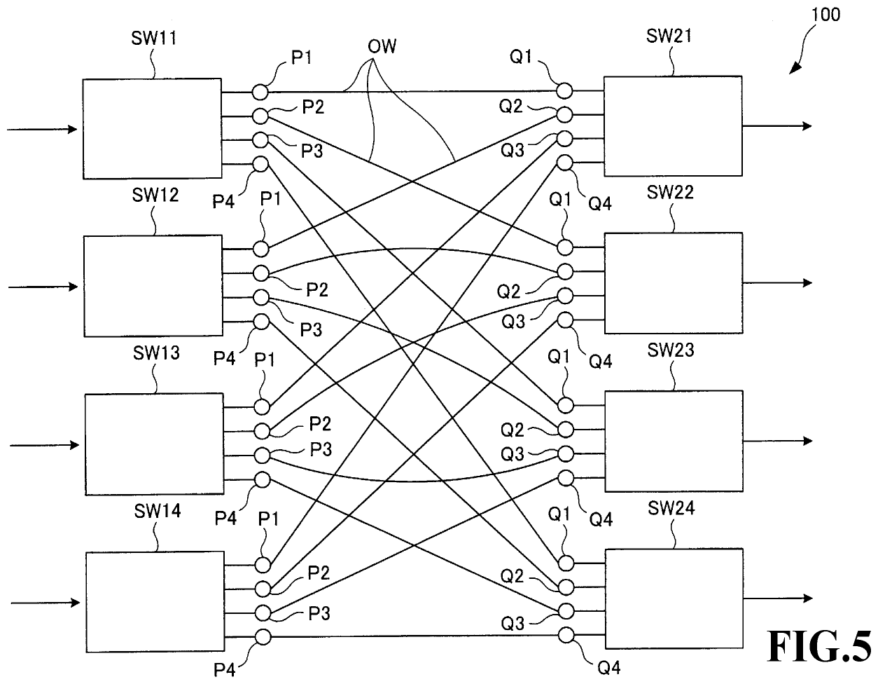

Here, in the conventional configuration of the optical switch shown in FIG. 5, two connection optical waveguides OW are allowed to cross each other in the crossing point of the connection optical waveguides OW, whereas in the present embodiment, as shown in FIG. 2, three or more connection optical waveguides OW are allowed to cross each other in one crossing point, thereby reducing the number of crossings. FIG. 2 shows an example of the case where a maximum of three connection optical waveguides OW are allowed to cross each other in one crossing point. The points where three connection optical waveguides OW are allowed to cross in one crossing point are encircled by broken lines in FIG. 2.

It should be noted that in the present embodiment, all of the crossings of the connection optical waveguides OW are made by using MMI optical waveguides OW_{MMI} as shown in FIG. 3 (the structure using the MMI optical waveguides OW_{MMI} is referred to as an MMI crossing structure). The MMI optical waveguide OW_{MMI} has a structure having any width with 1 input 1 output, and has a length that is twice the beat length.

In the MMI crossing structure, the connection optical waveguides OW are allowed to cross each other in a center portion (hereinafter referred to as the position corresponding to the beat length) of the MMI optical waveguide OW_{MMI} corresponding to the beat length. If loss and crosstalk in the MMI crossing structure having three connection optical waveguides OW crossing in one point are equivalent to the performance (loss, crosstalk) in the structure having two connection optical waveguides OW crossing in one point without using the MMI crossing structure, it is possible to achieve low loss and low crosstalk by reducing the number of crossings, thereby greatly contributing to the increase in the number of ports.

It should be noted that according to the present embodiment, as can be seen from FIG. 2, the number of crossings can be reduced by N/2 for the conventional connection optical waveguide OW having a maximum number of crossings.

Furthermore, in general, regarding the crossing of the connection optical waveguides OW, the connection optical waveguides OW are allowed to cross each other one by one, and as a crossing angle is closer to orthogonal, loss and crosstalk are reduced. Meanwhile, in the present embodiment, the MMI crossing structure is introduced into all of the crossing parts of the connection optical waveguides OW, so that multiple crossings with low loss and low crosstalk can be achieved.

For example, in the case of an MMI crossing structure having a width for exciting a 1^{st} mode, a proportion of a 0^{th} mode reaches a peak in the position corresponding to the beat length with respect to a waveguide direction, and the MMI crossing structure becomes less likely to be affected by the side wall of the connection optical waveguides OW. Accordingly, it is possible to prevent light from leaking out to other connection optical waveguides OW that are allowed to cross in the position corresponding to the beat length, reduce crosstalk, and further reduce dispersion caused by other connection optical waveguides OW, and thus crossing loss can be reduced.

In addition, even in a case where three or more connection optical waveguides OW are allowed to cross each other and a crossing angle is set at an acute angle, it is expected to reduce loss and crosstalk in the MMI crossing structure in the same manner, and thus it is possible to further reduce loss per unit crossing by collecting multiple crossings at one point.

Note that although crossing angles are preferably equal as shown in FIG. 3 in the MMI crossing structure, it is expected to produce the same effect in various embodiments other than the above embodiment.

In the present embodiment, it is possible to reduce the number of crossings as compared to the case where a maximum number of crossings of the connection optical waveguides OW is (N−1)×(N−1) in the conventional optical switch shown in FIG. 5, i.e., in a case where three connection optical waveguides OW are allowed to cross each other in one point, a maximum number of crossings of the connection optical waveguides OW is expressed by (N−1)×(N−1)−N/2.

In this case, regarding the number of crossings and a loss value, comparison on the assumption of the actual number of ports is shown in Table 1.

TABLE 1

| | Maximum value | | | |
|---|---|---|---|---|
| | | The number of | | Loss |
| | The number of | crossings in | | (@0.1 dB) |
| | crossings in | the | Loss (@0.1 dB) | in the |
| | the first | conventional | in the first | conventional |
| N | embodiment | example | embodiment | example |
| 4 | 7 | 9 | 0.7 | 0.9 |
| 8 | 45 | 49 | 4.5 | 4.9 |
| 16 | 217 | 225 | 21.7 | 22.5 |

As shown in Table 1, according to the N×N optical switch 10 of the present embodiment, it is possible to reduce the number of crossings of the connection optical waveguides OW, thereby reducing crossing loss caused by the crossing of the waveguides.

In Table 1, an example of allowing three connection optical waveguides OW to cross each other at the same time is shown in the present embodiment, but the optical loss can be further reduced by increasing the number of connection optical waveguides OW crossing each other at the same time.

Note that in the present embodiment, the example of making the crossing of the connection optical waveguides OW by using the MMI optical waveguides OW_{MMI} is shown, but the present invention is not limited to the above-described embodiment. By employing a structure having three or more connection optical waveguides OW crossing each other in one point (a structure having one connection optical waveguide OW crossing other two or more connection optical waveguides OW in one point), it is possible to reduce loss and crosstalk as compared to the conventional structure.

### Second Embodiment

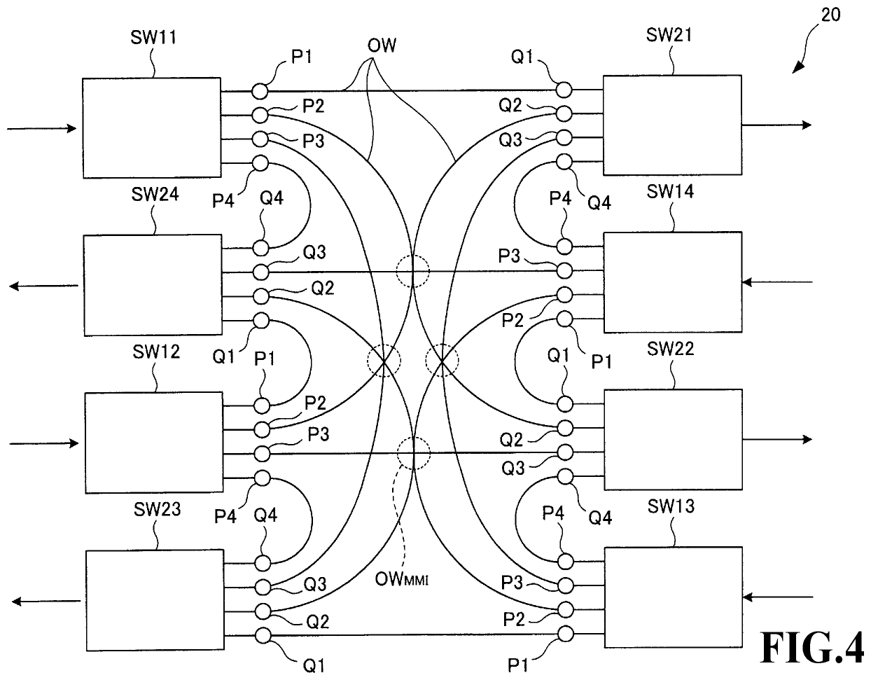

With reference to FIG. 4, an N×N optical switch according to the second embodiment of the present invention will be described. As an example, a case where N=4 will be described.

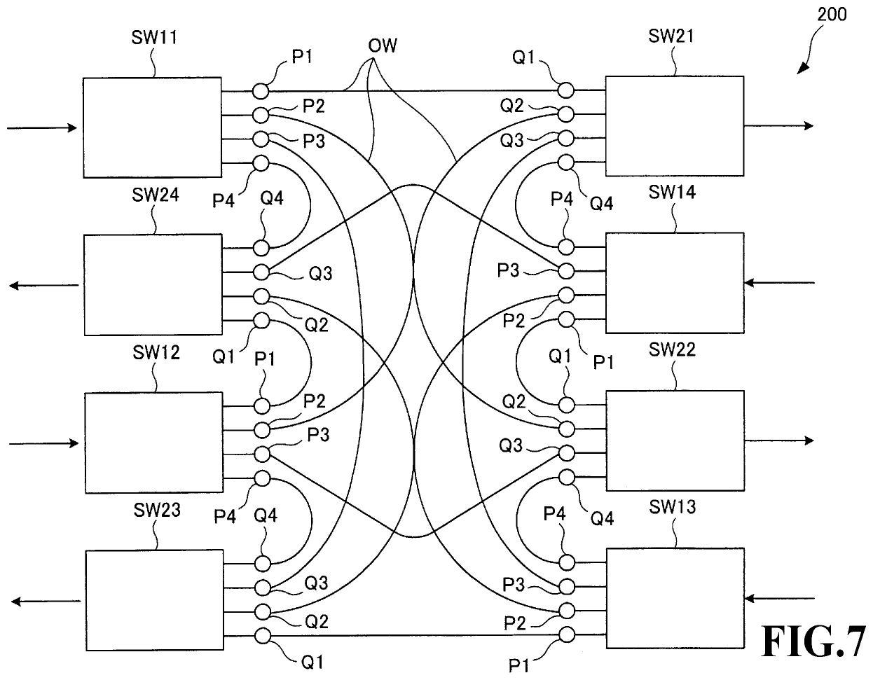

First, FIG. 7 shows a 4×4 optical switch 200, which has achieved reduction of the number of crossings by changing the alignment of input side 1×4 optical switches SW11-SW14 and output side 4×1 optical switches SW21-SW24 by referring to PTL 2. The 4×4 optical switch 200 shown in FIG. 7 has a structure of alternately arranging the input sides and the output sides instead of aligning the input side 1×4 optical switches SW11-SW14 and aligning the output side 4×1 optical switches SW21-SW24 opposite to the input side 1×4 optical switches SW11-SW14 as shown in FIG. 5.

More specifically, on one end surface, the input side 1×4 optical switch SW11, the output side 4×1 optical switch SW24, the input side 1×4 optical switch SW12, and the output side 4×1 optical switch SW23 are arranged in this order, and on the other end surface, the output side 4×1 optical switch SW21, the input side 1×4 optical switch SW14, the output side 4×1 optical switch SW22, and the input side 1×4 optical switch SW13 are arranged in this order.

Output ports P1-P4 of the respective input side 1×4 optical switches SW11-SW14 and input ports Q1-Q4 of the respective output side 4×1 optical switches SW21-SW24 are connected in the following state.

More specifically, the output ports P1, P4 located in the two ends of the input side 1×N optical switch SW11 are respectively connected to the input ports Q1, Q4 located in the end portions of the output side N×1 optical switches SW21, SW24 that are adjacent to the input side 1×N optical switch SW11 and are different from each other by connection optical waveguides that do not cross other connection optical waveguides; and among the output ports of the input side 1×N optical switch SW11, the output ports P2, P3 located other than in the two ends are respectively connected to the input ports Q2, Q3 located other than the two ends of the output side N×1 optical switches SW22, SW23 that are not adjacent to the input side 1×N optical switch SW11 and are different from each other by connection optical waveguides that cross other connection optical waveguides.

Furthermore, the output ports P1, P4 located in the two ends of the input side 1×N optical switch SW12 are respectively connected to the input ports Q1, Q4 located in the end portions of the output side N×1 optical switches SW24, SW23 that are adjacent to the input side 1×N optical switch SW12 and are different from each other by connection optical waveguides that do not cross other connection optical waveguides; and among the output ports of the input side 1×N optical switch SW12, the output ports P2, P3 located other than in the two ends are respectively connected to the input ports Q2, Q3 located other than in the two ends of the output side N×1 optical switches SW21, SW22 that are not adjacent to the input side 1×N optical switch SW12 and are different from each other by connection optical waveguides that cross other connection optical waveguides.

Furthermore, the output ports P1, P4 located in the two ends of the input side 1×N optical switch SW13 are respectively connected to the input ports Q1, Q4 located in the end portions of the output side N×1 optical switches SW23, SW22 that are adjacent to the input side 1×N optical switch SW13 and are different from each other by connection optical waveguides that do not cross other connection optical waveguides; and among the output ports of the input side 1×N optical switch SW13, the output ports P2, P3 located other than in the two ends are respectively connected to the input ports Q2, Q3 located other than in the two ends of the output side N×1 optical switches SW24, SW21 that are not adjacent to the input side 1×N optical switch SW13 and are different from each other by connection optical waveguides that cross other connection optical waveguides.

Furthermore, the output ports P1, P4 located in the two ends of the input side 1×N optical switch SW14 are respectively connected to the input ports Q1, Q4 located in the end portions of the output side N×1 optical switches SW22, SW21 that are adjacent to the input side 1×N optical switch SW14 and are different from each other by connection optical waveguides that do not cross other connection optical waveguides; and among the output ports of the input side 1×N optical switch SW14, the output ports P2, P3 located other than in the two ends are respectively connected to the input ports Q2, Q3 located other than in the two ends of the output side N×1 optical switches SW23, SW24 that are not adjacent to the input side 1×N optical switch SW14 and are different from each other by connection optical waveguides that cross other connection optical waveguides.

With such an arrangement, it is possible to reduce the number of crossings as compared to the configuration of the N×N optical switch shown in FIG. 5, i.e., the number of crossings of the connection optical waveguide OW with respect to other connection optical waveguides OW is (N−2)×(N/2) times at the maximum ((4−2)×(4/2)=4 times if N=4). Also to this configuration, the structure of the present invention can be applied.

As compared to the 4×4 optical switch 200 shown in FIG. 7, the 4×4 optical switch 20 shown in FIG. 4 has different paths of the connection optical waveguides OW. The arrangement of the input side 1×N optical switches SW11-SW14 and the output side 4×1 optical switches SW21-SW24 and the connection state between the output ports P1-P4 of the respective input side 1×4 optical switches SW11-SW14 and the input ports Q1-Q4 of the respective output side 4×1 optical switches SW21-SW24 are the same as those in FIG. 7, so a detailed description will be omitted.

As shown in FIG. 4, in the present embodiment, the 4×4 optical switch 20 has not only crossings of two waveguides but also crossings of three waveguides like the first embodiment. Points in which three connection optical waveguides OW are allowed to cross each other are encircled by broken lines in FIG. 4. In this case, a maximum number of crossings can be greatly reduced as compared to the conventional N×N optical switch shown in FIG. 5, i.e., the number of crossings is (N−1)×(N−2)/2 times at the maximum ((4−1)×(4−2)/2=3 times if N=4). In this case, regarding the number of crossings and a loss value, comparison on the assumption of the actual number of ports is shown in Table 2.

TABLE 2

| | Maximum value | | | |
|---|---|---|---|---|
| | | The number of | Loss | |
| | The number of | crossings in | (@0.1 dB) | Loss (@0.1 dB) |
| | crossings in | the | in the | in the |
| | the second | conventional | second | conventional |
| N | embodiment | example | embodiment | example |
| 4 | 3 | 9 | 0.3 | 0.9 |
| 8 | 21 | 49 | 2.1 | 4.9 |
| 16 | 105 | 225 | 10.5 | 22.5 |

As shown in Table 2, according to the N×N optical switch 20 of the present embodiment, it is possible to reduce the number of crossings of the connection optical waveguides OW, thereby reducing crossing loss caused by the crossing of the waveguides.

In Table 2, an example of allowing three connection optical waveguides OW to cross each other at the same time is shown, but the optical loss can be further reduced by increasing the number of connection optical waveguides OW crossing each other at the same time. Note that also in the present embodiment, by using an MMI crossing structure in a waveguide crossing portion, crossings with low loss and low crosstalk can be achieved.

### REFERENCE SIGNS LIST

10, 20 4×4 optical switch (N×N optical switch)
SW11-SW14 input side 1×4 optical switch (input side 1×N optical switch)
SW21-SW24 output side 4×1 optical switch (output side N×1 optical switch)
P1-P4 output port of input side optical switch
Q1-Q4 input port of output side optical switch
OW connection optical waveguide
OW_{MMI}MMI optical waveguide

1. An N×N optical switch comprising: N input side 1×N optical switches each having N (where N is an integer equal to or greater than 3) output ports; N output side N×1 optical switches each having N input ports; and connection optical waveguides connecting the output ports and the input ports,
wherein part of the connection optical waveguides cross two or more of the other connection optical waveguides in one point, and
an MMI crossing structure is used in a crossing portion in which the connection optical waveguide crosses the other connection optical waveguides.

2. (canceled)

3. The N×N optical switch according to claim 1, wherein the input side 1×N optical switches and the output side N×1 optical switches are separately aligned such that the output ports and the input ports are opposite to each other,
the output port in one end of the input side 1×N optical switch being located in one end among the input side 1×N optical switches is connected to the input port in one end of the output side N×1 optical switch being located in one end among the output side N×1 optical switches by the connection optical waveguide that does not cross the other connection optical waveguides,
the output port in the other end of the input side 1×N optical switch being located in the other end among the input side 1×N optical switches is connected to the input port in the other end of the output side N×1 optical switch being located in the other end among the output side N×1 optical switches by the connection optical waveguide that does not cross the other connection optical waveguides,
the output ports located other than in one end of the input side 1×N optical switch being located in one end among the input side 1×N optical switches are connected to the input ports of the output side N×1 optical switches being located other than in one end among the output side N×1 optical switches and being different from each other by the connection optical waveguides that cross the other connection optical waveguides,
the output ports located other than in the other end of the input side 1×N optical switch being located in the other end among the input side 1×N optical switches are connected to the input ports of the output side N×1 optical switches being located other than in the other end among the output side N×1 optical switches and being different from each other by the connection optical waveguides that cross the other connection optical waveguides, and
the output ports of the input side 1×N optical switches being located other than in two ends among the input side 1×N optical switches are connected to the input ports of the output side N×1 optical switches being different from each other by the connection optical waveguides that cross the other connection optical waveguides.

4. The N×N optical switch according to claim 1, wherein the input side 1×N optical switches and the output side N×1 optical switches are alternately arranged in alignment,
the output ports located in two ends of the input side 1×N optical switch are connected to the input ports located in end portions of the output side N×1 optical switches being adjacent to the input side 1×N optical switch and being different from each other by the connection optical waveguides that do not cross the other connection optical waveguides, and
among the output ports of the input side 1×N optical switch, the output ports located other than in two ends are connected to the input ports located other than in two ends of the output side N×1 optical switches not being adjacent to the input side 1×N optical switch and being different from each other by the connection optical waveguides that cross the other connection optical waveguides.

5. The N×N optical switch according to claim 1, wherein the input side 1×N optical switches, the output side N×1 optical switches, and the connection optical waveguides are formed as monolithic integration on a same semiconductor substrate.

6. The N×N optical switch according to claim 1, wherein crossing angles in the crossing portion in which the connection optical waveguide crosses the other connection optical waveguides are equal.

7. The N×N optical switch according to claim 3, wherein the input side 1×N optical switches, the output side N×1 optical switches, and the connection optical waveguides are formed as monolithic integration on a same semiconductor substrate.

8. The N×N optical switch according to claim 3, wherein crossing angles in the crossing portion in which the connection optical waveguide crosses the other connection optical waveguides are equal.

9. The N×N optical switch according to claim 4, wherein the input side 1×N optical switches, the output side N×1 optical switches, and the connection optical waveguides are formed as monolithic integration on a same semiconductor substrate.

10. The N×N optical switch according to claim 4, wherein crossing angles in the crossing portion in which the connection optical waveguide crosses the other connection optical waveguides are equal.
